(19) United States
(12) Patent Application Publication
(10) Pub. No.: US 2023/0323906 A1
(43) Pub. Date: Oct. 12, 2023

(54) APPARATUS FOR LINKING ARTICLES OF FURNITURE

(71) Applicant: Ditto Sales, Inc. dba Versteel, Jasper, IN (US)

(72) Inventors: Derrick Hochgesang, Huntingburg, IN (US); Tyler Deaton, Evansville, IN (US); Eric Harrison, Florence, WI (US)

(21) Appl. No.: 17/658,913

(22) Filed: Apr. 12, 2022

(51) Int. Cl. F16B 12/20

(52) U.S. Cl. CPC F16B 12/20; F16B 2012/103

(57) ABSTRACT

An apparatus is provided for linking two articles of furniture that includes a generally U-shaped link. The two articles of furniture include hollow beams that define a link engagement opening in an inner face opposite an abutting outer face of the beam. The link engagement opening includes a center opening sized to receive part of the link into the interior of the hollow beam and a linking slot in communication with the center opening. The link engagement opening and link are configured so that the link can be moved from the center opening into the linking slot of the hollow beams of both articles of furniture. The link engagement opening further includes a storage slot in which the storage slot and link are configured so that the link can be moved from the linking slot, into the center opening and then into the storage slot to store the link.

### BACKGROUND

The present invention relates to articles of furniture and, in particular, to an apparatus for connecting or linking articles of furniture to one another, such as seating furniture of the type used in an office environment, including chairs, lounges, and tables.

Office environments typically include chairs, benches and lounges, together with side tables, for use in conference rooms, waiting rooms, and at other locations within the office environment. The chairs typically include a single seat, while benches and lounges typically include one-, two-, and/or three-seat versions. Side tables may be placed next to the chairs and/or lounges.

A wide variety of connecting arrangements are known for linking or “ganging” adjacent chairs, benches or lounges to one another, and/or for connecting side tables to the seating. The ability to link furniture allows the user to arrange the furniture as desired and as suited for the particular space. For example, the Immix® modular bench system and the Elly™ modular seating system sold by Ditto Sales, Inc. of Jasper, Indiana, allows the components to be mixed and matched and arranged for privacy, collaboration or convenience.

Some seating and/or tables include structures integrated into the articles of furniture for connecting the articles of furniture together. Other arrangements include structurally separate connectors, such as brackets, which are fastened to the undersides of the furniture articles by screws or other fasteners with the use of tools. One disadvantage with this arrangement is that the furniture articles may need to be tilted on their sides, or even up-ended, to allow installation of the brackets. In any event, the brackets are typically difficult to install beneath the furniture when the furniture is in its use orientation. The brackets may also be visible between the adjacent furniture articles, and may therefore detract from the aesthetic appearance of the furniture.

Another approach is shown in U.S. Pat. No. 7,806,474, issued to Kimball International, Inc. on Oct. 5, 2010, which discloses an elongated extruded connector that clips onto channel beams on the underside of a lounge and/or table. The connector extends along most of the length of the channel beams and requires the specially configured beams to receive the connector. Moreover, the connector is a separate component from the furniture so that it must be stored when not in use.

There is a need for an apparatus for linking that can be retained with the furniture, that is readily accessible and that is easy to use.

### SUMMARY OF THE DISCLOSURE

An apparatus is provided for linking includes two articles of furniture, in which each article of furniture includes a frame with a hollow beam configured and arranged to abut each other at an outer face thereof when the articles of furniture are linked. The apparatus comprises a link including an elongated main plate and a pair of wings extending from opposite sides of the main plate to define a generally U-shaped channel, each of the pair of wings including a flange at an end thereof opposite and substantially parallel to the main plate. The flange of each wing includes a hook portion projecting inward from the corresponding wing and overlapping the main plate. The hook portion defines a groove between the corresponding wing and the hook portion.

In another feature of the apparatus, the hollow beam of each article of furniture includes a link engagement opening defined in an inner face of the hollow beam opposite the abutting outer face of the beam. The link engagement opening includes a center opening sized to receive one of said pair of wings therein to allow introduction of the wing into the interior of the hollow beam with the other wing outside the beam. The link engagement opening further includes a linking slot in communication with the center opening that has a width sized to slidably receive the flange therein with a bottom edge of the linking slot disposed within the groove to prevent removal of said link from said linking slot. The link is formed of a resiliently deflectable material so that each of said pair of wings can deflect outward relative to the other of the pair of wings to facilitate engagement of the link to the two beams.

In another feature, the link engagement opening in the hollow beam of at least one of the two articles of furniture includes a storage slot in communication with the center opening. The storage slot has a width sized to slidably receive the main plate with one of the pair of wings inside the corresponding hollow beam. The link can be stored within the storage slot and maintained with the particular article of furniture until it is desired to link the article with another article of furniture.

### DESCRIPTION OF THE DRAWINGS

FIG. 1 is a top perspective view of a link of the apparatus of the present disclosure.

FIG. 2 is a bottom perspective view of a link of the apparatus of the present disclosure.

FIG. 3 is a top view of the link shown in FIG. 1.

FIG. 4 is an end view of the link shown in FIG. 1.

FIG. 5 is a bottom view of the link shown in FIG. 1.

FIG. 6 is cross-sectional view of the link shown FIG. 3, as viewed in the direction of the arrows.

FIG. 7 is bottom perspective view of furniture that can be linked by the apparatus of the present disclosure.

FIG. 8 is an enlarged perspective view underneath the furniture shown in FIG. 7, showing the link of FIG. 1 in a first stowed position.

FIG. 9 is an end cut-away view of the link and beam of the furniture shown in FIG. 8 with the link in the first stowed position.

FIG. 10 is an enlarged perspective view underneath the furniture shown in FIG. 7, showing the link of FIG. 1 in a second intermediate position.

FIG. 11 is an enlarged perspective view underneath the furniture shown in FIG. 7, showing the link of FIG. 1 in a third pivoting position.

FIG. 12 is an end cut-away view of the link and beam of the furniture shown in FIG. 11 with the link in the third pivoting position.

FIG. 13 is an enlarged perspective view underneath the furniture shown in FIG. 7, showing the link of FIG. 1 in a fourth pivoting position

FIG. 14 is an end cut-away view of the link and beam of the furniture shown in FIG. 13 with the link in the fourth pivoting position.

FIG. 15 is an enlarged perspective view underneath the furniture shown in FIG. 7, showing the link of FIG. 1 in a fifth locking position

FIG. 16 is an enlarged perspective view underneath the furniture shown in FIG. 7, showing the link of FIG. 1 in a final locking position

FIG. 17 is an end cut-away view of the link and beam of the furniture shown in FIG. 16 with the link in the final locking position

FIG. 18 is a cut-away view into the beam showing the link in the final locking position of FIGS. 17-18.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

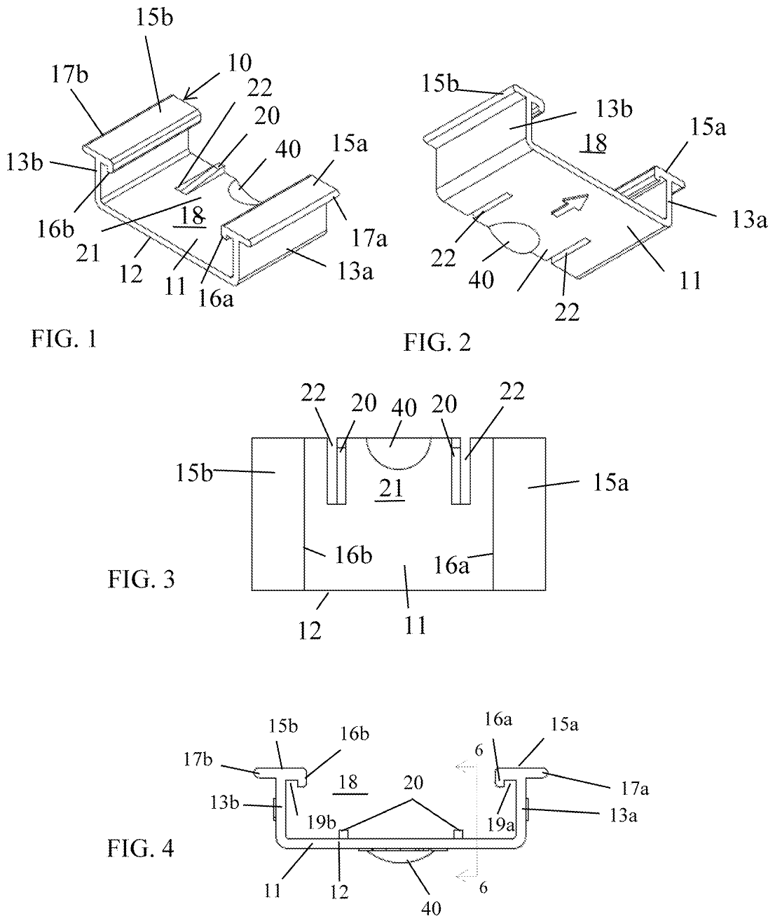

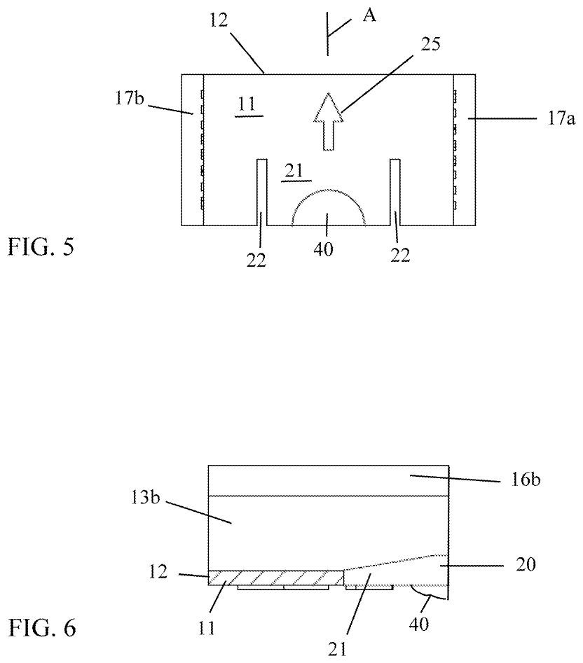

A link 10 for linking furniture is shown in FIGS. 1-6. The link 10 is generally U-shaped with a main plate 11 that is generally rectangular and that is flanked at its sides by a pair of wings 13a, b that extend generally perpendicular from the main plate. The wings 13a, b terminate in a corresponding flange 15a, b that is offset from the plate and can extend generally parallel to the main plate 11. As best seen in FIG. 4, each flange 15a, b includes a hook portion 16a, b that overlaps a portion of the main plate, and an outer tab portion 17a, b that extends sideways from the corresponding wing. As can be appreciated from FIGS. 1 and 4, the main plate 11 and wings 13a, b define a channel 18 along an axis A (FIG. 5). Each hook portion 16a, b extends downward toward the main plate, offset from the inner surface of the associated wing 13a, b, to form a corresponding groove 19a, b. The main plate 13 includes a resilient latch component that include pair of latches 20 mounted on or integral with a latch plate 21 that is defined in the main plate by a pair of slots 22. It can be appreciated that the slots 22 allow the latch plate 21 to deflect relative to the rest of the main plate 11. The latches 20 are inclined, as shown in FIG. 6, with the height of the latches increasing away from the leading edge 12 of the plate 11. In an alternative embodiment, the deflectable latch plate can be replaced with at least one prong, and preferably two prongs, which incorporate the inclined latch 20 and that are resiliently deflectable on their own relative to the main plate.

The main plate 11 includes indicia 25 on the bottom face, as shown in FIG. 5, which identifies the front of the plate, or the leading edge 12. As explained in more detail below, the indicia 25 points to the direction to move the link 10 to latch the link to the furniture being connected.

The link 10 is formed of a strong but resiliently deflectable material. In one embodiment, the link is formed as one piece from a plastic or a resin. In a specific embodiment, the link 10 is formed of Nylon 910 that is well-suited to fabrication in a 3D or additive printing process. The material of the link allows the latch plate 21 to deflect relative to the main plate when force is applied to the latch plate or prongs 20, and then spring back to a coplanar orientation with the main plate when the force is removed. The material of the plate also allows the wings 13a, b to deflect outward relative to each other and then resiliently return to the original U-shape.

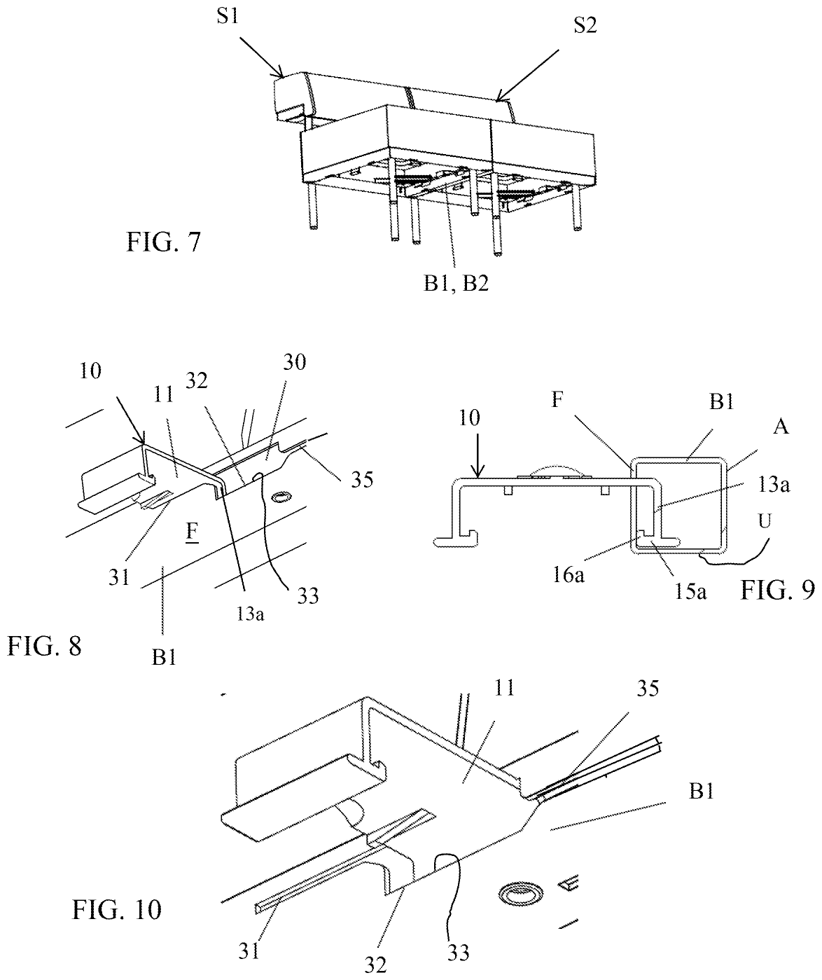

The link 10 is configured to engage adjacent articles of furniture and hold them together. In one specific application, the link 10 is part of a linking assembly incorporated into seating furniture S1, S2, which can be a pair of bench seats as shown in FIG. 7. The furniture S1, S2 include a base having a beam construction for strength and rigidity. In one embodiment, the furniture S1, S2 includes side beams B1, B2 that can abut each other when the two bench seats are linked. As shown in FIG. 9, the beams are generally hollow rectangular box beams that extend along the length of a side of the furniture. The linking assembly of the present disclosure includes a link engagement opening 30 defined through the wall of each side beam B1, B2, as shown in FIGS. 8 and 10. In particular, the link engagement openings 30 are defined in the inboard face F of each beam, and not in the abutting faces A of the beams. Each engagement opening 30 includes a storage slot 31 that leads to a center opening 32 and then to a linking slot 35. The link 10 is sized to fit through the center opening 32, as shown in FIG. 10, so that the link can be moved into the storage slot 31. Each center opening 32 is sized so that the wing 13a, b and flange 15a, b can fit through the opening 32, as depicted in FIG. 10. Once one wing 13a of the link 10 is within the interior of the beam B1, the link can be moved toward the storage slot 31, and in particular so that the main plate 11 extends into the slot 31, as shown in FIG. 8. A wing 13a and associated flange 15a of one side of the link is seated within the interior of the beam B1, as shown in FIG. 9. In this position, the link 10 is retained with the furniture S1 and is stored in that location until it is needed to link the furniture S1 with the furniture S2. It can be appreciated that the storage slot 31 has a width that is sufficient for the main plate 11 to slide within the slot. As can be appreciated from FIG. 8, the wing 13a is situated inside the beam and prevents the link 10 from being removed from the storage slot 31. Removal requires moving the link 11 to the center opening 32.

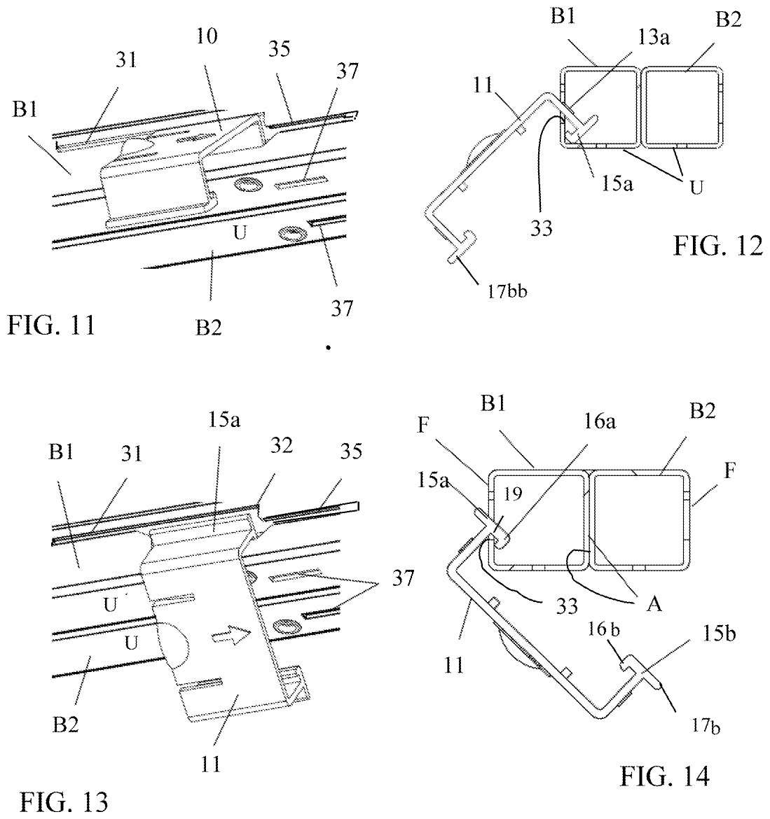

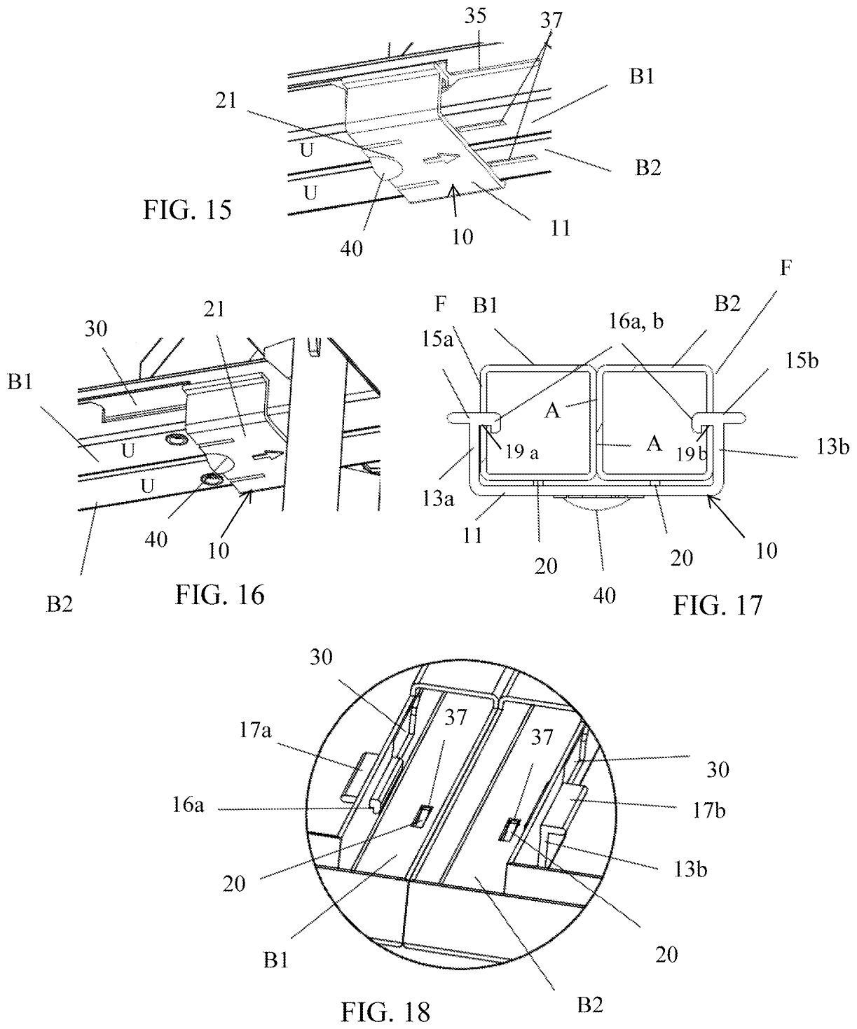

When it is desired to use the link, the link is moved in the direction of the arrow in the indicia 25 from the storage slot 31 into the center opening 32, as shown in FIG. 10. In this location, the link 10 can be pivoted downward, as shown in FIGS. 11-12. The outer tab 17b on the wing 13b can be used to pivot the link. In this position, a portion of the first wing 13a and the entire flange 15a is still seated within the interior of the beam B1. The wing 13a rests against the edge 33 of the center opening (FIGS. 9, 11) which acts as a fulcrum for pivoting the link further from the opening 30. As the link pivots further, the hook portion 16a engages the side wall of the beam B1 and the edge 33 is situated in the groove 19a, as shown in FIGS. 13-14. The hook portion thus allows the link 10 to swing under the beam B1 without being dislodged from the beam opening 30. The link 10 is pivoted through the positions shown in FIGS. 11-15 until the main plate 11 is generally parallel to the bottom or underside U of the beam B1 (FIG. 15). It can be appreciated that as the link is pivoted upward toward the second beam B2, the second hook portion 16b will contact the second beam B2. As the link is pivoted further upward, by manual pressure on the tab portion 17b, the second wing 13b will deflect outward as the hook portion 16b moves along the outer face F of the beam. Once the hook portion 16b reaches the center opening 32 of the second beam B2, the wing 13b resiliently snaps back to its original U-shaped configuration and the hook portion 13b moves into the opening 32. The link can be shifted upward while it is being pivoted so that the main plate 11 approaches the underside U of the two beams B1, B2. With this movement, the opposite wing 13 thus approaches the inboard face F of the other beam B2 and the hook portion 16 enters the center opening 32 of the other beam. It can be appreciated that the main plate 11 has a length between the wings 13a, 13b to accept the width of the two beams B1, B2 in a close fit to hold the two beams, and thus the articles of furniture, together.

In this position, the flanges 15 and hook portions 16 at each side of the link are disposed in the interior of their respective beams B1, B2. The link 10 can be pushed upward so that the main plate 11 contacts the underside U of each beam B1, B2 and, more importantly, so that the flanges 15a, b and grooves 19a, b are aligned with the linking slots 35 of each beam, as shown in FIGS. 15-17. As best seen in FIG. 8, the linking slot 35 is offset from the lower edge 33 of the center opening 32. Consequently, it is necessary to move the entire link upward until the flanges 15a, 15b are aligned with the linking slots 35 of the two beams B1, B2. The link 10 can then be moved in the direction of the arrow in the indicia 25 so that the flanges 15a, b simultaneously enter the linking slots 35 of both beams B1, B2, with the bottom edge of the linking slots disposed within respective grooves 19a, b. The linking slots 35 have a width sufficient for the flange to slide within the slot, but not large enough for the hook portion 16a, b to pass through. As the link is moved deeper into the linking slots, the latches 20 contact the underside U of the beams, causing the latch plate 21 to deflect downward until the latches 20 reach locking slots 37 defined in the bottom face or underside U of the beams. The prongs 20 then spring back to enter the slots 37, as shown in FIG. 18, as the latch plate 21 returns to its coplanar position within the main plate 11.

A finger depression 40 can be defined on the trailing edge of the latch plate 21 that can be used to deflect the latch plate 21 downward to release the latches 20 from the latch slots 37. The link 10 can then be moved back to the center opening 32, where the flange 15 of one side can be removed from the interior of the respective beam. The link essentially moves through the steps described above in reverse order until the main plate 11 is disposed within the storage slot 31 of one of the beams B1, B2. It can be appreciated that the link 10 can be stored in either beam B1, B2 of either of the seating S1, S2. Alternatively, only one of the beams includes the storage slot as part of the link engagement opening 30.

In a specific embodiment, the beams B1, B2 of the furniture S1, S2 can be about 3.0 inches wide, with the main plate 11 of the link 10 having a width between the wings 13a, b of 3.016 inches. The link can have a height from the bottom surface of the main plate to the top surface of the flange 15a, b of 1.0 inch. The linking slot 37 of each beam is 0.87 inches from the bottom surface of the beams so that the flanges 15a, b of the link can be disposed within the two slots. The storage slot 31 can also be at the same height. The link 10 has a length along the axis A of 2.0 inches, so the storage slot 31, center opening 32 and linking slot 35 of the beam opening 30 in each beam have lengths of at least 2.0 inches.

The linking apparatus of the present disclosure includes the link 10 and the engagement openings 30 in the beams B1, B2 of the respective seating S1, S2. For most seating, a single linking apparatus is all that is needed to solidly connect adjacent furniture. For instance, conventional seating, such as the bench seats S1, S2 of the present disclosure, have a depth of 36-48 inches. A single linking apparatus in the middle of the side beams are sufficient to keep the seating connected. In some cases, the furniture may be tables that are to be connected along a length that is greater than the depth of the typical seating. Longer beams may require multiple linking apparatuses along the length of the beams for a stable connection.

The present disclosure should be considered as illustrative and not restrictive in character. It is understood that only certain embodiments have been presented and that all changes, modifications and further applications that come within the spirit of the disclosure are desired to be protected.

What is claimed is:

1. A linking apparatus for linking two articles of furniture, each article of furniture including a frame with a hollow beam configured and arranged to abut each other at an outer face thereof when the articles of furniture are linked, the apparatus comprising:
a link including an elongated main plate and a pair of wings extending from opposite sides of said main plate to define a generally U-shaped channel, each of the pair of wings including a flange at an end thereof opposite and substantially parallel to said main plate, said flange including a hook portion projecting inward from the corresponding wing and overlapping said main plate, said hook defining a groove between the corresponding wing and the hook portion; and
the hollow beam of each article of furniture including a link engagement opening defined in an inner face of the hollow beam, said inner face opposite the abutting outer face of the corresponding beam, said link engagement opening including a center opening sized to receive one of said pair of wings therein and a linking slot in communication with said center opening, said linking slot having a width sized to slidably receive said flange therein with a bottom edge of said linking slot disposed within said groove to prevent removal of said link from said linking slot.

2. The linking apparatus of claim 1, wherein the link is formed of a resiliently deflectable material so that each of said pair of wings can deflect outward relative to the other of the pair of wings.

3. The linking apparatus of claim 1, wherein said link engagement opening in the hollow beam of at least one of the two articles of furniture includes a storage slot in communication with said center opening, said storage slot having a width sized to slidably receive the main plate with one of the pair of wings inside the corresponding hollow beam.

4. The linking apparatus of claim 1, wherein:
the hollow beam of at least one of the two articles of furniture includes a locking slot on a bottom face of the beam; and
said main plate includes a resilient latch component that is configured to engage said locking slot when said flange is received in said linking slot.

5. The linking apparatus of claim 4, wherein:
said resilient latch component includes a pair of spaced apart slots in said main plate defining a latch plate that is resiliently deflectable relative to said main plate; and
at least one latch on said latch plate configured to engage said locking slot.

6. The linking apparatus of claim 5, wherein said latch plate includes a depression at an edge of the latch plate, said depression configure to be manually engaged to manually deflect said latch plate relative to said main plate.

7. The linking apparatus of claim 1, wherein said flange includes a tab portion projecting outward from said wing, said flange configure to be manually engaged to move said link relative to the hollow beam.

8. A method for linking two articles of furniture using the linking apparatus of claim 1, comprising the steps of:
placing the two articles of furniture adjacent each other with the hollow beams of abutting each other;
introducing one of the pair of wings of the link through the center opening in the hollow beam of one of the articles of furniture with the other of the pair of wings outside the hollow beam;
positioning the link with a lower edge of the center opening disposed in the groove;
pivoting the link downward using the lower edge of the center opening as a fulcrum:
pivoting the link so that the main plate is beneath the underside or bottom face of the hollow beams of both articles of furniture;
pivoting the link upward so that hook portion of the other of the pair of wings contacts the hollow beam of the other of the articles of furniture;
pushing the link upward so that the contact with the hollow beam causes the outer of the pair of wings to deflect outward until the hook portion of the other of the pair of wings snaps into the center opening of the hollow beam of the other of the articles of furniture;
orienting the link with the flange of each of the pair of wings aligned with the linking slot of the beams of the two articles of furniture; and
sliding the flanges along the respective linking slots, thereby linking the two articles of furniture.

9. A method for stowing the link of the linking apparatus of claim 2, comprising the steps of:
introducing one of the pair of wings of the link through the center opening in the hollow beam of one of the articles of furniture with the other of the pair of wings outside the hollow beam;
orienting the link with the main body aligned with the storage slot; and
sliding the main plate along the storage slot to support the link on the hollow beam.

10. A link for linking two articles of furniture, comprising:
an elongated main plate;
a pair of wings extending from opposite sides of said main plate to define a generally U-shaped channel; and
a flange at an end of each of the pair of wings hereof opposite and substantially parallel to said main plate, said flange including a hook portion projecting inward from the corresponding wing and overlapping said main plate, said hook defining a groove between the corresponding wing and the hook portion,
wherein the pair of wings are formed of a resiliently deflectable material so that each of said pair of wings can deflect outward relative to the other of the pair of wings.

11. The linking apparatus of claim 10, wherein:
said main plate includes a pair of spaced apart slots that define a latch plate that is resiliently deflectable relative to said main plate; and
said latch plate includes at least one inclined latch thereon.

12. The linking apparatus of claim 11, wherein said latch plate includes a depression at an edge of the latch plate, said depression configure to be manually engaged to manually deflect said latch plate relative to said main plate.

13. The linking apparatus of claim 10, wherein said flange includes a tab portion projecting outward from said corresponding wing, said flange configure to be manually engaged to move said link.
